(19) United States
(12) Patent Application Publication
(10) Pub. No.: US 2006/0167966 A1
(43) Pub. Date: Jul. 27, 2006

(54) Grid computing system having node scheduler

(76) Inventors: Rajendra Kumar, Los Altos, CA (US); Sujoy Basu, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/008,717

(22) Filed: Dec. 9, 2004

(51) Int. Cl. G06F 15/16

(52) U.S. Cl. 709/201

(57) ABSTRACT

A scheduler for a grid computing system includes a node information repository and a node scheduler. The node information repository is operative at a node of the grid computing system. Moreover, the node information repository stores node information associated with resource utilization of the node. Continuing, the node scheduler is operative at the node. The node scheduler is configured to determine whether to accept jobs assigned to the node. Further, the node scheduler includes an input job queue for accepted jobs, wherein each accepted job is launched at a time determined by the node scheduler using the node information.

### BACKGROUND OF THE INVENTION

1. Field of the Invention

The present invention generally relates to grid computing systems. More particularly, the present invention relates to schedulers for grid computing systems.

2. Related Art

A grid computing system enables a user to utilize distributed resources (e.g., computing resources, storage resources, network bandwidth resources) by presenting to the user the illusion of a single computer with many capabilities. Typically, the grid computing system integrates in a collaborative manner various networks so that the resources of each network are available to the user. Moreover, the grid computing system generally has a grid distributed resource manager, which interfaces with the user, and a plurality of grid subdivisions, wherein each grid subdivision has the distributed resources. Each grid subdivision includes a plurality of nodes, wherein a node provides a resource.

The user can submit a job to the grid computing system via the grid distributed resource manager. The job may include input data, identification of an application to be utilized, and resource requirements for executing the job. The job may include other information. Typically, the grid computing system uses a scheduler having a hierarchical structure to schedule the jobs submitted by the user. The scheduler may perform tasks such as locating resources for the jobs, assigning jobs, and managing job loads. FIG. 1A illustrates a conventional scheduler 100 for a grid computing system. As shown in FIG. 1A, the conventional scheduler 100 includes a top grid scheduler 10 having an input job queue 20, wherein the top grid scheduler 10 is also known as the meta scheduler. Further, the conventional scheduler 100 includes a grid subdivision scheduler 30 having an input job queue 40 for each grid subdivision, wherein the grid subdivision scheduler 30 is also known as a local scheduler. Each grid subdivision scheduler 30 schedules jobs for the nodes in the grid subdivision.

FIG. 1B illustrates a conventional grid subdivision 200. As depicted in FIG. 1B, the conventional grid subdivision 200 has several components. These components include a grid subdivision scheduler 30 having an input job queue 40, a grid subdivision information repository 50 that stores information associated with nodes and the conventional grid subdivision 200, and a plurality of nodes 70A-70D, wherein each node 70A-70D includes a job launcher 71A-71D. The components of the conventional grid subdivision 200 are coupled to a network 80 to facilitate communication. Examples of information stored in the grid subdivision information repository 50 include available nodes 70A-70D, resources of the nodes 70A-70D, and resource utilization of each node 70A-70D.

After the user submits the job to the grid computing system, the job is sent to the input job queue 20 of the top grid scheduler 10. In turn, the top grid scheduler 10 selects a grid subdivision and submits the job to its grid subdivision scheduler 30. Here, the top grid scheduler 10 has selected the grid subdivision 200 of FIG. 1B. Hence, the job is sent to the input job queue 40 of the grid subdivision scheduler 30. Once the job is placed in the input job queue 40, the job is scheduled based on policies in effect in the grid subdivision 200 or grid subdivision scheduler 30. The grid subdivision scheduler 30 may query the grid subdivision information repository 50 to identify nodes that are available. Further, once the grid subdivision scheduler 30 selects a node (e.g., node 70A-70D) for running a job from its input job queue 40, the job is sent to the node (e.g., node 70A-70D) and started by the job launcher (e.g., job launcher 71A-71D) of the selected node (e.g., node 70A-70D). From then on, the node's resources are time sliced between multiple jobs, which may be running on that node.

This scheduling scheme causes several problems. First, when the grid subdivision scheduler 30 wants to assign a job to a node, the grid subdivision scheduler 30 needs dynamic information about the resource utilization (e.g., cpu, bandwidth, memory, and storage utilization) for that node at that point in time. The grid subdivision information repository 50 stores resource utilization information received from the nodes 70A-70D. Unfortunately, it is difficult to update dynamic information such as resource utilization on a fine granularity of time (e.g., every 10 microseconds) because this would increase the communication traffic of the network 80, reducing bandwidth for executing jobs. As the number of nodes in the grid subdivision 200 is increased, the communication traffic caused by nodes updating dynamic information such as resource utilization on a fine granularity of time increases substantially, leading to network overload and poor performance by the grid computing system. Thus, the grid computing system would not scale to thousands of nodes in each grid subdivision.

Secondly, since the grid subdivision information repository 50 does not keep track of dynamic behavior of the nodes with a fine granularity of time, the grid subdivision scheduler 30 schedules multiple jobs to a node to maximize throughput based on several heuristics. However, this may slow down performance considerably if multiple running jobs compete for scarce available resources (e.g., cpu, memory, storage, network bandwidth, etc.) of the node.

### SUMMARY OF THE INVENTION

A scheduler for a grid computing system includes a node information repository and a node scheduler. The node information repository is operative at a node of the grid computing system. Moreover, the node information repository stores node information associated with resource utilization of the node. Continuing, the node scheduler is operative at the node. The node scheduler is configured to determine whether to accept jobs assigned to the node. Further, the node scheduler includes an input job queue for accepted jobs, wherein each accepted job is launched at a time determined by the node scheduler using the node information.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1A illustrates a conventional scheduler for a grid computing system.

FIG. 1B illustrates a conventional grid subdivision of a grid computing system.

FIG. 2 illustrates a grid computing system in accordance with an embodiment of the present invention.

FIG. 3A illustrates a scheduler for a grid computing system in accordance with an embodiment of the present invention.

FIG. 3B illustrates a grid subdivision of the grid computing system of FIG. 2 in accordance with an embodiment of the present invention.

FIG. 4 illustrates a flow chart showing a method of scheduling jobs in a grid computing system in accordance with an embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

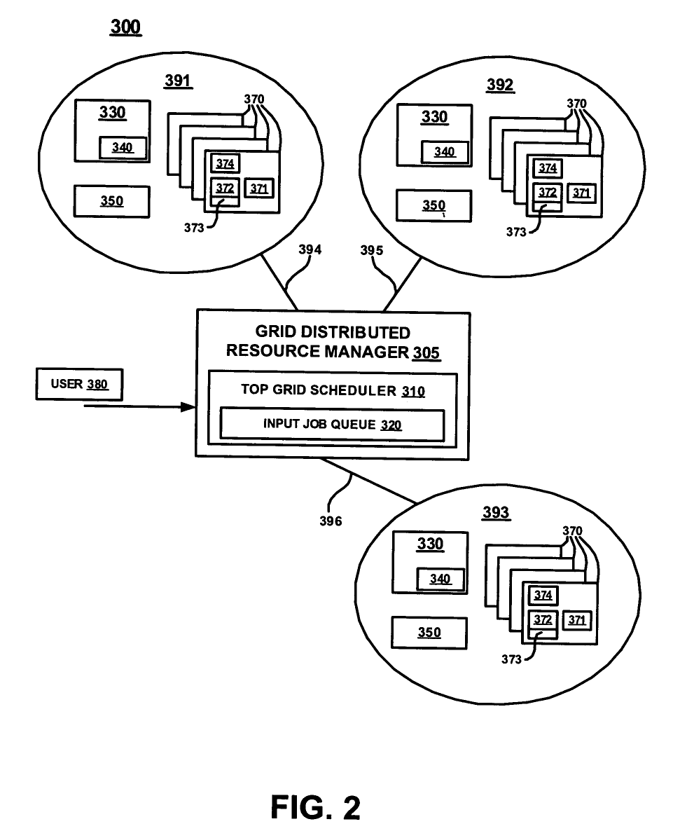

FIG. 2 illustrates a grid computing system 300 in accordance with an embodiment of the present invention. As depicted in FIG. 2, the grid computing system 300 includes a grid distributed resource manager 305 and a plurality of grid subdivisions 391-393. The grid distributed resource manager 305 provides a user interface to enable a user 380 to submit a job to the grid computing system 300. Further, the grid distributed resource manager 305 includes a top grid scheduler 310 having an input job queue 320. The grid distributed resource manager 305 is coupled to the grid subdivisions 391-393 via connections 394, 395, and 396, respectively.

Each grid subdivision 391-393 has a plurality of networked components. These networked components include a grid subdivision scheduler 330 having an input job queue 340, a grid subdivision information repository 350 that stores information associated with nodes and the grid subdivision, and a plurality of nodes 370. Each node 370 includes a job launcher 371, a node scheduler 372 having an input job queue 373, and a node information repository 374. The node information repository 374 is operative at the node 370. Further, the node information repository 374 stores node information associated with resource utilization (e.g., cpu, bandwidth, memory, and storage utilization) of the node 370. The node information includes information gathered at a fine granularity of time and information gathered at a coarse granularity of time.

The node scheduler 372 is also operative at the node 370. Moreover, the node scheduler 372 is configured to determine whether to accept jobs assigned to the node 370. The input job queue 373 of the node scheduler 372 receives the accepted jobs. Each accepted job is launched at a time determined by the node scheduler 372 using the node information.

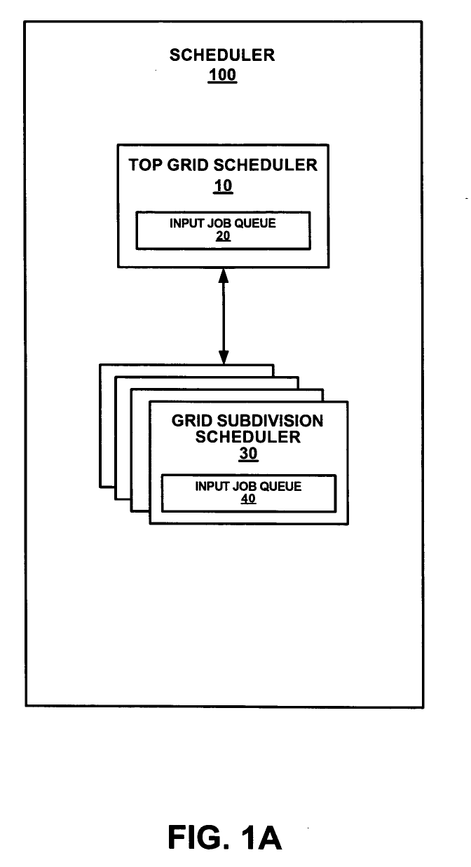

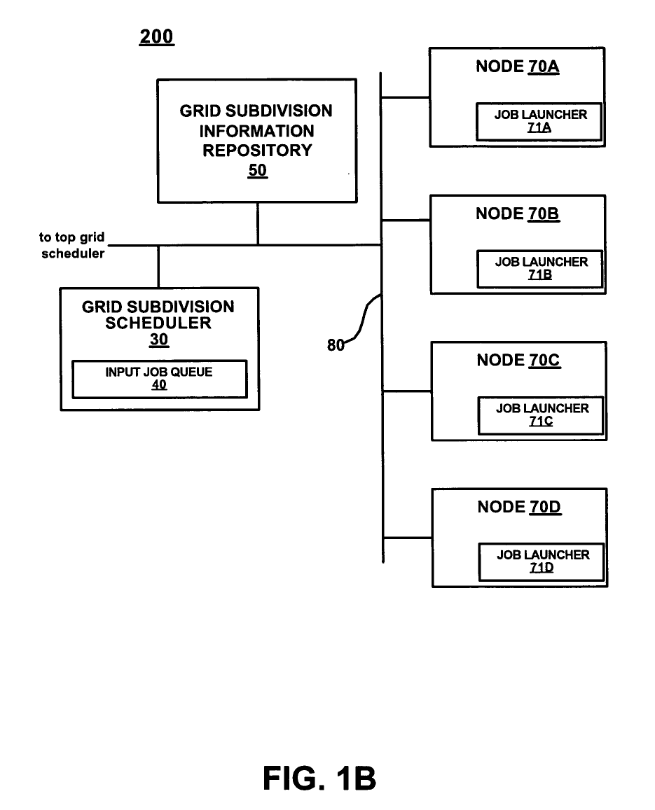

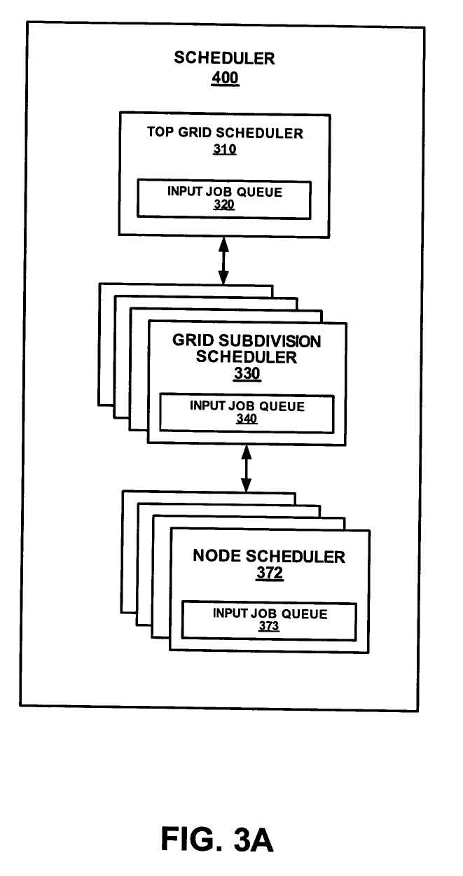

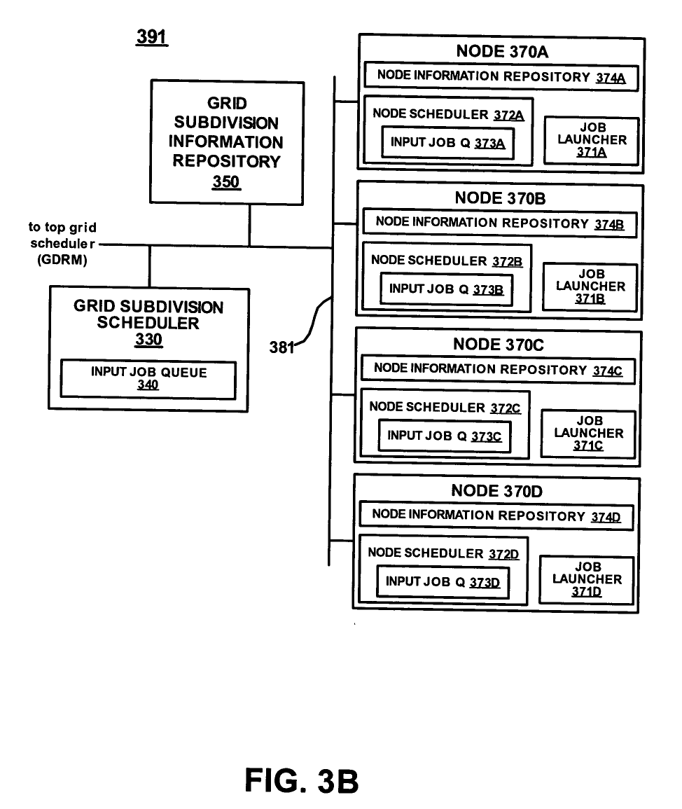

FIG. 3A illustrates a scheduler 400 for a grid computing system 300 in accordance with an embodiment of the present invention. As shown in FIG. 3A, the scheduler 400 includes a top grid scheduler 310 having an input job queue 320. Further, the scheduler 400 includes a grid subdivision scheduler 330 having an input job queue 340 for each grid subdivision 391-393. Each grid subdivision scheduler 330 schedules jobs for the nodes 370 in the grid subdivision 391-393. Moreover, the scheduler 400 includes a node scheduler 372 having an input job queue 373 at each node 370 of the grid subdivision 391-393. Unlike the conventional scheduler 100 (FIG. 1), the scheduler 400 is hierarchical and scalable.

FIG. 3B illustrates a grid subdivision 391 of the grid computing system 300 of FIG. 2 in accordance with an embodiment of the present invention. The grid subdivision 391 includes a grid subdivision scheduler 330 having an input job queue 340, a grid subdivision information repository 350 that stores information associated with nodes and the grid subdivision 391, and a plurality of nodes 370A-370D. Each node 370A-370D includes a job launcher 371A-371D, a node scheduler 372A-372D having an input job queue 373A-373D, and a node information repository 374A-374D. The components of the grid subdivision 391 are coupled to a network 381 to facilitate communication. Examples of information stored in the grid subdivision information repository 350 include available nodes 370A-370D, resources of the nodes 370A-370D, and resource utilization of each node 370A-370D. As describes above, each node information repository 374A-374D stores node information associated with resource utilization (e.g., cpu, bandwidth, memory, and storage utilization) of respective node 370A-370D. The node information includes information gathered at a fine granularity of time and information gathered at a coarse granularity of time.

The node scheduler (e.g., node scheduler 372A-372D) addresses the problems described above. While the grid subdivision scheduler 330 will continue to schedule a job to nodes 370-370D of the grid subdivision 391, the node scheduler (e.g., node scheduler 372A-372D) implements admission control. That is, the node scheduler (e.g., node scheduler 372A-372D) may accept the job or reject the job. This decision is made based on node policies and the node information stored in the respective node information repository 374A-374D. As described above, job-scheduling decisions that are based on current resource utilization information (e.g., cpu, bandwidth, memory, and storage utilization) of a node maximize performance of the grid computing system 300. Each node information repository 374A-374D stores this dynamic node information of the respective node 370A-370D and gathers the node information at a fine granularity of time and at a coarse granularity of time, without needing to introduce communication traffic on the network 381. Further, the node information may be sent to the grid subdivision information repository 350 in an aggregate form and on a periodic basis that minimizes communication traffic on the network 381.

Continuing, if a job is accepted by the node scheduler (e.g., node scheduler 372A-372D), the accepted job is placed in its respective input job queue and is scheduled for launching at an appropriate time by the node scheduler (e.g., node scheduler 372A-372D). The node scheduler (e.g., node scheduler 372A-372D) launches one or more accepted jobs and monitors the node information stored in the respective node information repository 374A-374D. Further, the node scheduler (e.g., node scheduler 372A-372D) determines whether to launch an additional accepted job based on the node information stored in the respective node information repository 374A-374D. By fine-tuning the execution of jobs at the node level, adverse effects due to multiple jobs competing for finite memory, storage, bandwidth, and cpu resources can be minimized.

Furthermore, the grid subdivision scheduler 330 can also perform load balancing by monitoring the size of the input job queues 373A-373D of the node schedulers 372A-372D. For example, one or more of the accepted jobs pending in the input job queues 373A-373D can be reassigned based on the number of accepted jobs pending in the input job queues 373A-373D. Also, accepted jobs waiting in the input job queues 373A-373D of the node schedulers 372A-372D would consume substantially less memory resources than the launched jobs waiting on a resource in the kernel of the node 370A-370D.

Thus, the scheduler 400 provides several benefits. These benefits include a more scalable architecture for the grid computing system 300, more autonomy at the node level to improve performance, reduced need for frequent gathering and transmitting dynamic node information to the grid subdivision information repository 350 from the nodes 370 through communication traffic, and ability to perform passive load balancing across nodes 370.

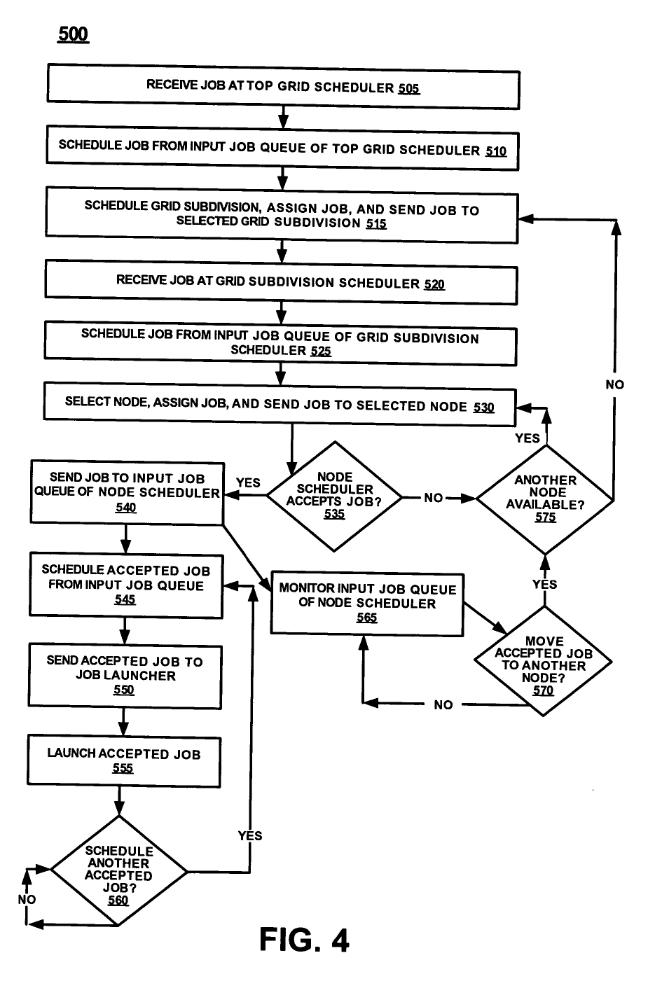

FIG. 4 illustrates a flow chart showing a method 500 of scheduling jobs in a grid computing system 300 in accordance with an embodiment of the present invention. Reference is made to FIGS. 2-3B.

At 505, the top grid scheduler 310 receives a job submitted by a user 380 to the grid computing system 300. Further, at 510, the top grid scheduler 310 schedules a job from its input job queue 320. The top grid scheduler 310 may utilize any number of criteria in scheduling jobs.

At 515, the top grid scheduler 310 selects a grid subdivision (e.g., grid subdivision 391) to execute the job, assigns the job, and sends the job to the selected grid subdivision 391. The top grid scheduler 310 may query an information repository of the grid computing system in selecting the grid subdivision. Continuing, at 520, the job is received at the grid subdivision scheduler 330 of the selected grid subdivision 391. At 525, the grid subdivision scheduler 330 schedules a job from its input job queue 340. The grid subdivision scheduler 330 may utilize any number of criteria in scheduling jobs.

Moreover, at 530, the grid subdivision scheduler 330 selects a node (e.g., node 370A) to execute the job, assigns the job, and sends the job to the selected node 370A. The grid subdivision scheduler 330 may query the grid subdivision information repository 350 in selecting the node.

Furthermore, at 535, the node scheduler 372A of node 370A decides whether to accept the job. This decision is made based on node policies and the node information stored in the node information repository 374A. If the node scheduler 372A accepts the job, the method 500 continues to step 540. Otherwise, if the node scheduler 372A rejects the job, the method 500 proceeds to step 575, which is described below.

At 540, the node scheduler 372A of node 370A accepts the job and sends it to its input job queue 373A. At 545, the node scheduler 372A schedules an accepted job from its input job queue 373A. The node scheduler 372A may utilize any number of criteria in scheduling jobs. For instance, the accepted job is scheduled for launching at a time determined by the node scheduler 372A using the node information stored in the node information repository 374A.

Continuing, at 550, the node scheduler 372A sends the accepted job to the job launcher 371A of node 370A. At 555, the job launcher 371A launches the accepted job. Further, at 560, the node scheduler 372A determines whether to schedule another accepted job for launching. The node scheduler 372A may utilize the node information stored in the node information repository 374A in making this determination. If the node scheduler 372A decides not to schedule another accepted job for launching, the method 500 returns to step 560 to continue to monitor the progress of jobs and the node information stored in the node information repository 374A. Otherwise, the method 500 proceeds to step 545, where another accepted job is scheduled for launching.

As described above, at 540, the node scheduler 372A of node 370A accepts the job and sends it to its input job queue 373A. Moreover, at 565, the grid subdivision scheduler 330 monitors the input job queue 373A of the node scheduler 372A. At 570, the grid subdivision scheduler 330 determines whether to move one or more accepted jobs to another node. If the grid subdivision scheduler 330 decides not to move any accepted jobs from the input job queue 373A of the node scheduler 372A, the method 500 returns to step 565, where the grid subdivision scheduler 330 continues to monitor the input job queue 373A of the node scheduler 372A. Otherwise, the method 500 proceeds to step 575.

At 575, the grid subdivision scheduler 330 determines whether another node in the grid subdivision 391 is available to execute the accepted job(s) being moved from the input job queue 373A of the node scheduler 372A of node 370A or whether another node in grid subdivision 391 is available to execute the job rejected by node scheduler 372A of node 370A in step 535. If the grid subdivision scheduler 330 determines that another node is available, the method 500 proceeds to step 530, where the grid subdivision scheduler 330 selects another node to execute the job, assigns the job, and sends the job to the other node. Otherwise, the method 500 proceeds to step 515, where the top grid scheduler 310 selects another grid subdivision to execute the job, assigns the job, and sends the job to the other grid subdivision 391.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A scheduler for a grid computing system comprising:
a node information repository operative at a node of said grid computing system for storing node information associated with resource utilization of said node; and
a node scheduler operative at said node, wherein said node scheduler is configured to determine whether to accept jobs assigned to said node, and wherein said node scheduler includes an input job queue for accepted jobs, each accepted job launched at a time determined by said node scheduler using said node information.

2. The scheduler as recited in claim 1 wherein said node scheduler accepts jobs based on node policies and said node information.

3. The scheduler as recited in claim 1 wherein said node information includes information gathered at a fine granularity of time and information gathered at a coarse granularity of time.

4. The scheduler as recited in claim 1 wherein said node scheduler launches one or more accepted jobs and monitors said node information.

5. The scheduler as recited in claim 4 wherein said node scheduler determines whether to launch an additional accepted job based on said node information.

6. The scheduler as recited in claim 1 wherein one or more of said accepted jobs pending in said input job queue are reassigned based on number of accepted jobs pending in said input job queue.

7. A scheduler for a grid computing system comprising:
at least one top grid scheduler operative at a user interface level of said grid computing system;
at least one grid subdivision scheduler operative at a corresponding grid subdivision of said grid computing system;
at least one node scheduler operative at a corresponding node of said corresponding grid subdivision; and
a node information repository operative at said corresponding node for storing node information associated with resource utilization of said corresponding node,
wherein said top grid scheduler receives a job submitted by a user to said grid computing system and assigns said job to said corresponding grid subdivision, wherein said grid subdivision scheduler receives and assigns said job to said corresponding node, wherein said node scheduler is configured to determine whether to accept said job assigned to said corresponding node, and wherein said node scheduler includes an input job queue for accepted jobs, each accepted job launched at a time determined by said node scheduler using said node information.

8. The scheduler as recited in claim 7 wherein said node scheduler accepts jobs based on node policies and said node information.

9. The scheduler as recited in claim 7 wherein said node information includes information gathered at a fine granularity of time and information gathered at a coarse granularity of time.

10. The scheduler as recited in claim 7 wherein said node scheduler launches one or more accepted jobs and monitors said node information.

11. The scheduler as recited in claim 10 wherein said node scheduler determines whether to launch an additional accepted job based on said node information.

12. The scheduler as recited in claim 7 wherein said grid subdivision scheduler reassigns one or more of said accepted jobs pending in said input job queue based on number of accepted jobs pending in said input job queue.

13. A method of scheduling jobs in a grid computing system, said method comprising:
receiving a job submitted by a user at a top grid scheduler operative at a user interface level of said grid computing system;
assigning said job from said top grid scheduler to a particular grid subdivision of a plurality grid subdivisions of said grid computing system;
assigning said job from a grid subdivision scheduler operative at said particular grid subdivision to a particular node of a plurality nodes of said particular grid subdivision;
if a node scheduler operative at said particular node accepts said job, placing said job in an input job queue of said node scheduler; and
launching an accepted job from said input job queue at a time determined by said node scheduler using node information associated with resource utilization of said particular node.

14. The method as recited in claim 13 wherein said node scheduler accepts jobs based on node policies and said node information.

15. The method as recited in claim 13 wherein said node information includes information gathered at a fine granularity of time and information gathered at a coarse granularity of time.

16. The method as recited in claim 13 wherein said launching said accepted job comprises:
launching one or more accepted jobs; and
monitoring said node information.

17. The method as recited in claim 16 wherein said launching said accepted job further comprises:
determining whether to launch an additional accepted job based on said node information.

18. The method as recited in claim 13 further comprising:
reassigning to another node one or more of said accepted jobs pending in said input job queue based on number of accepted jobs pending in said input job queue.

19. The method as recited in claim 13 further comprising:
if said node scheduler rejects said job, assigning said job from said grid subdivision scheduler to another node of said plurality nodes of said particular grid subdivision.

20. The method as recited in claim 13 further comprising:
if said particular grid subdivision fails to execute said job, assigning said job from said top grid scheduler to another grid subdivision of said plurality grid subdivisions.
